(19) United States
(12) Patent Application Publication
(10) Pub. No.: US 2012/0002275 A1
(43) Pub. Date: Jan. 5, 2012

(54) OPTICAL ELEMENT SWITCHING APPARATUS AND MICROSCOPE SYSTEM

(75) Inventors: Kunihiko Hayashi, Kanagawa (JP); Yu Hirono, Tokyo (JP)

(73) Assignee: SONY CORPORATION, Tokyo (JP)

(21) Appl. No.: 13/165,937

(22) Filed: Jun. 22, 2011

(30) Foreign Application Priority Data
Jun. 30, 2010 (JP) 2010-150525

(51) Int. Cl. G02B 21/00; G02B 7/14

(52) U.S. Cl. 359/381; 359/813; 359/814

(57) ABSTRACT

An optical element switching apparatus is provided that includes: a connecting portion connecting a transmitting portion with a traveling body portion via a predetermined elastic body and displacing the traveling body portion in each of first and second directions in a range of an elastic displacement width greater than a unit travel distance; a holding portion applying a force greater than an elastic force occurring in the connecting portion to the traveling body portion shifted to the travel limit position, in a direction opposite to the direction where the elastic force acts, so as to hold the traveling body portion at a travel limit position; and a control portion adapted to control a drive force generating portion to supply a drive force capable of shifting the traveling body portion farther than the travel limit position when the traveling body portion is to be shifted.

### CROSS REFERENCES TO RELATED APPLICATIONS

The present application claims priority to Japanese Priority Patent Application JP 2010-150525 filed in the Japanese Patent Office on Jun. 30, 2010, the entire contents of which is hereby incorporated by reference.

### BACKGROUND

The present application relates to an optical element switching apparatus and a microscope system that are suitable to be applied to a field where e.g. a biological sample is enlarged and observed.

In the past, microscopes have widely been used in which optical elements such as objective lenses and ocular lenses are designed to be exchangeable in order to vary an enlargement factor of an image in accordance with the contents and types of observation objects.

Some microscopes widely use the so-called revolver-type (i.e., the rotating nose piece type) configured to facilitate the exchange of mainly objective lenses. Further, a microscope is proposed in which the switching of the objective lenses is automated by driving the revolver by a pulse motor or the like. (See e.g. Japanese Patent Laid-Open No. 2002-207173, FIGS. 1 and 2).

On the other hand, some microscopes are proposed as below. If the objective lenses to be exchanged are only two types, the two objective lenses are disposed on a travel portion traveling on a straight line. In addition, the objective lenses are made switchable by manually shifting the travel portion. (See e.g. Japanese Patent Laid-Open No. 2007-328063, FIGS. 1 to 4.)

### SUMMARY

Incidentally, the microscope in which the two objective lenses are disposed on the straight line and switched from each other may be intended to automate the switching of the objective lenses. In such a case, a method is conceivable for shifting the travel portion in the linear direction by use of the pulse motor as in Japanese Patent Laid-Open No. 2002-207173.

However, if a stepping motor is used, the stopping position where the drive of the stepping motor is stopped cannot be controlled precisely. The stopping position can be set only at relatively rough accuracy, such as at an interval of 200 μm.

In such a case, an optical axis of an optical system in the microscope will be out of alignment. In particular, if the imaging element is installed at the focal position of the ocular lens to image an observation object, there is a problem in that such misalignment of the optical axis significantly lowers the quality of the image.

It is desirable to provide an optical element switching apparatus that can significantly enhance positional accuracy when switching between optical elements and a microscope system that can significantly enhance positional accuracy when switching between image forming lenses.

According to an embodiment, there is provided an optical element switching apparatus including: a main body portion in which an optical path is set; a traveling body portion on which two types of optical elements are mounted; a shifting portion adapted to shift the traveling body portion with respect to the main body portion so that an optical axis of any one of the optical elements is aligned with the optical axis of the optical path by shifting any one of the optical axes of the two types of optical elements on a predetermined travel line; a travel limit position defining portion adapted to define a travel limit position of the traveling body portion with respect to the main body portion, in relation to each of a first direction along the travel line and a second direction opposite to the first direction; a drive force generating portion generating a drive force adapted to shift the traveling body portion in the first or second direction by a predetermined unit travel distance and transmitting the drive force to a predetermined transmission portion; a connecting portion connecting the transmitting portion with the traveling body portion via a predetermined elastic body and displacing the traveling body portion with respect to the transmitting portion in each of the first and second directions within a range of an elastic displacement width greater than the unit travel distance; a holding portion applying a force greater than an elastic force occurring in the connecting portion to the traveling body portion shifted to the travel limit position, in a direction opposite to the direction where the elastic force acts, so as to hold the traveling body portion at the travel limit position; and a control portion adapted to control the drive force generating portion to supply a drive force capable of shifting the traveling body portion farther than the travel limit position when the traveling body portion is to be shifted.

The optical element switching apparatus of the present disclosure allows the traveling body portion to get still at the travel limit position accurately by the elastic action of the connecting portion and the holding action of the holding portion although the travel distance of the traveling body portion shifted by the drive force generating portion is on a unit travel distance basis.

According to another embodiment, there is provided a microscope system including: a main body portion mounted with an objective lens focusing on an imaging object; an imaging element imaging the imaging object via the objective lens and a predetermined optical element; a traveling body portion mounted with two types of image forming lenses each forming an image of the imaging object on the imaging element; a shifting portion adapted to shift the traveling body portion with respect to the main body portion so that respective optical axes of the two types of image forming lenses are each shifted on a predetermined travel line to align any one of the optical axes of the image forming lenses with the optical axis of the optical path; a travel limit position defining portion adapted to define a travel limit position of the traveling body portion with respect to the main body portion, in relation to each of a first direction along the travel line and a second direction opposite to the first direction; a drive force generating portion generating a drive force adapted to shift the traveling body portion in the first or second direction by a predetermined unit travel distance and transmitting the drive force to predetermined transmission portion; a connecting portion connecting the transmitting portion with the traveling body portion via a predetermined elastic body and displacing the traveling body portion with respect to the transmitting portion in each of the first and second directions in a range of an elastic displacement width greater than the unit travel distance; a holding portion applying a force greater than an elastic force occurring in the connecting portion to the traveling body portion shifted to the travel limit position, in a direction opposite the direction where the elastic force acts, so as to hold the traveling body portion at the travel limit position; and a control portion adapted to control the drive force generating portion to supply a drive force capable of shifting the traveling body portion farther than the travel limit position when the traveling body portion is to be shifted.

The microscope system of the present disclosure allows the traveling body portion to get still at the travel limit position accurately by the elastic action of the connecting portion and the holding action of the holding portion although the travel distance of the traveling body portion shifted by the drive force generating portion is on a unit travel distance basis.

According to the present disclosure, the traveling body portion can get still at the travel limit position accurately by the elastic action of the connecting portion and the holding action of the holding portion although the travel distance of the traveling body portion shifted by the drive force generating portion is on a unit travel distance basis. Thus, the present disclosure can realize an optical element switching apparatus that can significantly enhance positional accuracy when switching between the optical elements and a microscope system that can significantly enhance positional accuracy when switching between the image forming lenses.

Additional features and advantages are described herein, and will be apparent from the following Detailed Description and the figures.

### BRIEF DESCRIPTION OF THE FIGURES

FIG. 1 is a schematic diagram illustrating a general configuration of a microscope system;

FIG. 2 is a schematic diagram illustrating a configuration of a control unit;

FIG. 3 is a schematic perspective view illustrating a configuration of the lens barrel switching portion;

FIG. 4 is a schematic front view of illustrating the configuration of the lens barrel switching portion;

FIG. 5 is a schematic plan view illustrating the configuration of the lens barrel switching portion;

FIG. 6 is a schematic left lateral view illustrating the configuration of the lens barrel switching portion;

FIG. 7 is a schematic exploded perspective view illustrating a configuration of a connecting portion;

FIG. 8 is a schematic view illustrating switching operation (1) of an image forming lens;

FIG. 9 is a schematic view illustrating switching operation (2) of the image forming lens;

FIG. 10 is a schematic view illustrating switching operation (3) of the image forming lens;

FIG. 11 is a schematic view illustrating switching operation (4) of the image forming lens;

FIG. 12 is a schematic view illustrating switching operation (5) of the image forming lens;

FIG. 13 is a schematic flowchart illustrating an image forming lens switching processing procedure;

FIG. 14 is a schematic perspective view of a configuration of a pressing portion;

FIG. 15 is a schematic rear view illustrating a configuration of the pressing portion;

FIG. 16 is a schematic front view illustrating the configuration of the pressing portion; and

FIGS. 17A and 17B are schematic views illustrating the relationship between an inclination angle of an upper surface of a cam guide and a pressing force.

### DETAILED DESCRIPTION

Embodiments of the present application will be described below in detail with reference to the drawings.

### 1. First Embodiment

### 2. Other Embodiments

### First Embodiment

### 1-1. Schematic Configuration of Microscope System

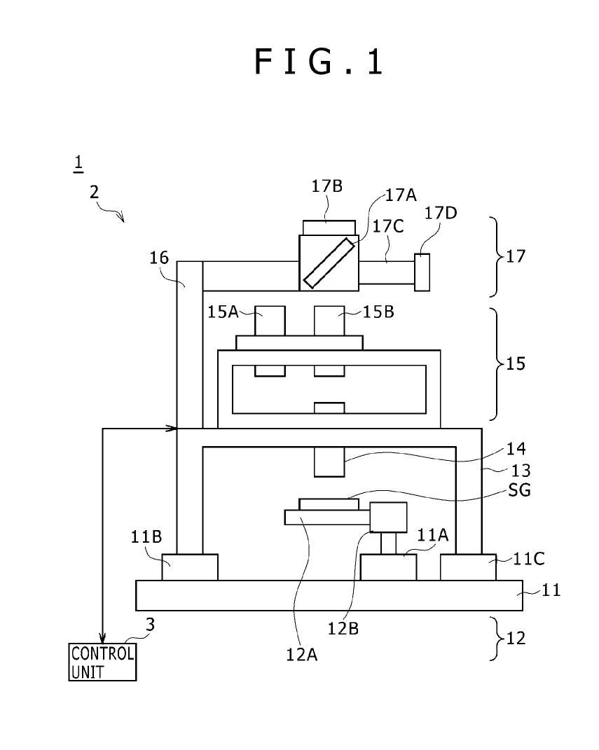

Referring to FIG. 1, a microscope system 1 according to a first embodiment includes a microscope unit 2 which images slide glass SG by enlarging it at a given magnification, and a control unit 3 which controls the microscope unit 2.

Incidentally, FIG. 1 schematically illustrates a general configuration of the microscope system 1 for convenience of description.

The slide glass SG is fixedly mounted with a biological sample SPL by a predetermined fixation method. The biological sample SPL is smear cells or the tissue strip of connective tissue of blood or the like, of epithelial tissue or of both the tissue. The tissue strip or the smear cells are subjected to stain as necessary. Examples of the stain include not only general stain typified by HE (Hematoxylin Eosin) stain, Giemsa stain, or Papanicolaou stain but also fluorescence stain such as FISH (Fluorescence In-Situ Hybridization) or enzyme antibody technique.

The microscope unit 2 is configured such that a base 11 serves as a foundation. A stage portion 12 is mounted on an upper surface of the base 11 via an absorbing member 11A absorbing vibrations. In addition, an optical system holding portion 13 is mounted on the upper surface of the base 11 via absorbing members 11B, 11C.

The optical system holding portion 13 is wholly formed like a box with its bottom opened and configured solidly not to cause vibrations or the like. The optical system holding portion 13 is provided with such a space as to be able to house the stage portion 12 therein. A generally tubular objective lens 14 is secured to the upper surface of the stage portion 12.

The stage portion 12 includes a stage 12A holding the slide glass SG and a stage shifting portion 12B shifting the stage 12A in a 3-axis direction.

In actuality, the control unit 3 is adapted to control the stage portion 12 to shift the stage 12A in the 3-axis direction to locate a desired portion of the biological sample SPL secured to the slide glass SG at a position focused by the objective lens 14.

In addition to the objective lens 14, a lens barrel switching portion 15 switching between a plurality of image forming lenses and an imaging system holding portion 16 holding an imaging portion 17 are mounted to the upper surface of the optical system holding portion 13.

The lens barrel switching portion 15 is provided with two kinds of image forming lenses 15A, 15B each forming an image of the biological sample SPL that has passed through the objective lens 14. In addition the lens barrel switching portion 15 is designed to be capable of switching between the two kinds of image forming lenses in accordance with the control of the control unit 3 (detailed later). Incidentally, the image forming lenses 15A, 15B are designed to have different optical magnification.

In the imaging portion 17, a half mirror 17A allows the image formed by the image forming lens 15A or 15B to pass therethrough at a given ratio to reach an imaging element 17B and the remainder of the image to be reflected and reach an AF (Auto Focus) imaging element 17D via an AF optical system 17C.

The imaging element 17B is composed of e.g. a CMOS (Complementary Metal Oxide Semiconductor) with the predetermined number of pixels or the like. In addition, the imaging element 17B images the biological sample SPL, creates image data, and sends the image data thus created to the control unit 3.

On the other hand, the AF optical system 17C allows the image of the biological sample SPL to be subjected to such given optical processing as to facilitate the determination the focused condition of the image to let the AF imaging element image it.

The AF imaging element 17D images the biological sample SPL, creates AF image date and sends it to the control unit 3. In response to this, the control unit 3 determines the focused condition based on the AF image data and shiftably controls the stage portion 12 in the vertical direction to focus the objective lens 14 on the biological sample SPL.

Incidentally, while shiftably controlling the stage portion 12 so as to shift the imaging position of the biological sample SPL, the control unit 3 allows the imaging element 17B to sequentially image the imaging portion and combine the obtained image date together.

In this way, the microscope system 1 is configured to produce an extremely large image that has the number of pixels in significant excess of the number of pixels of the imaging element 17B and represents the entire range of the biological sample SPL secured to the slide glass SG.

As described above, in the microscope system 1, while the lens barrel switching portion 15 switches between the image forming lenses 15A and 15B, the images of the biological sample SPL are sequentially imaged at desired enlarged magnification.

### 1-2. Configuration of the Control Section

The control unit 3 controls each portion of the microscope unit 2, performs predetermined image processing and the like on the image data of the image object obtained by the imaging, and stores them in a predetermined storage portion.

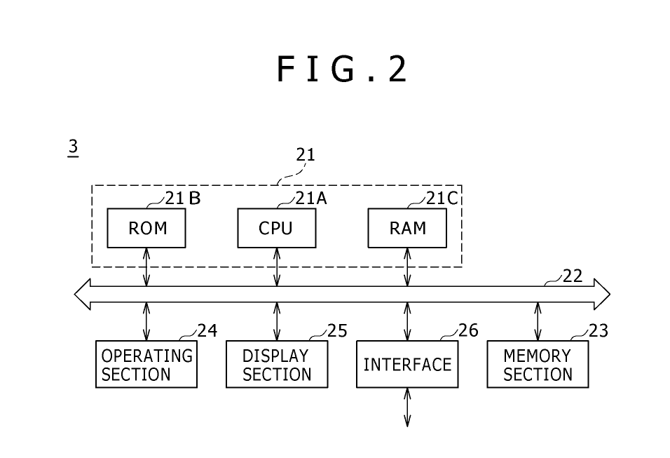

Referring to FIG. 2, the control unit 3 is mainly composed of a control section 21 including a CPU (Central Processing Unit) 21A performing various kinds of arithmetic processing, a ROM (Read Only Memory) 21B previously storing data, and a RAM (Random Access Memory) 21C temporarily storing data.

In the control section 21, while using the RAM 21C as a work area, the CPU 21A executes various programs read from the ROM 21B and a storage section 23 via a bus 22 and allows the storage section 23 to store various data therein.

The storage section 23 is composed of e.g. a hard disk drive, an optical disc drive or a flash memory and is designed to store large volumes of various data such as image data with high definition.

An operating section 24 is composed of e.g. a keyboard, various switches or a touch panel. In addition, the operating section 24 is designed to receive user's operative input and supplies an operative command indicating the operative contents thereof to the control section 21.

A display section 25 is composed of e.g. a liquid crystal display, an EL (Electro Luminescence) display or a plasma display and is designed to be capable of displaying various display screens or image data picked up as images.

An interface 26 is designed to transmit and receive various control signals, detection signals or various data among the stage shifting portion 12B, lens barrel switching portion 15, imaging element 17B, AF imaging element 17D, etc. of the microscope unit 2.

### 1-3. Configuration of the Lens Barrel Switching Portion

A description is next given of the configuration of the lens barrel switching portion 15.

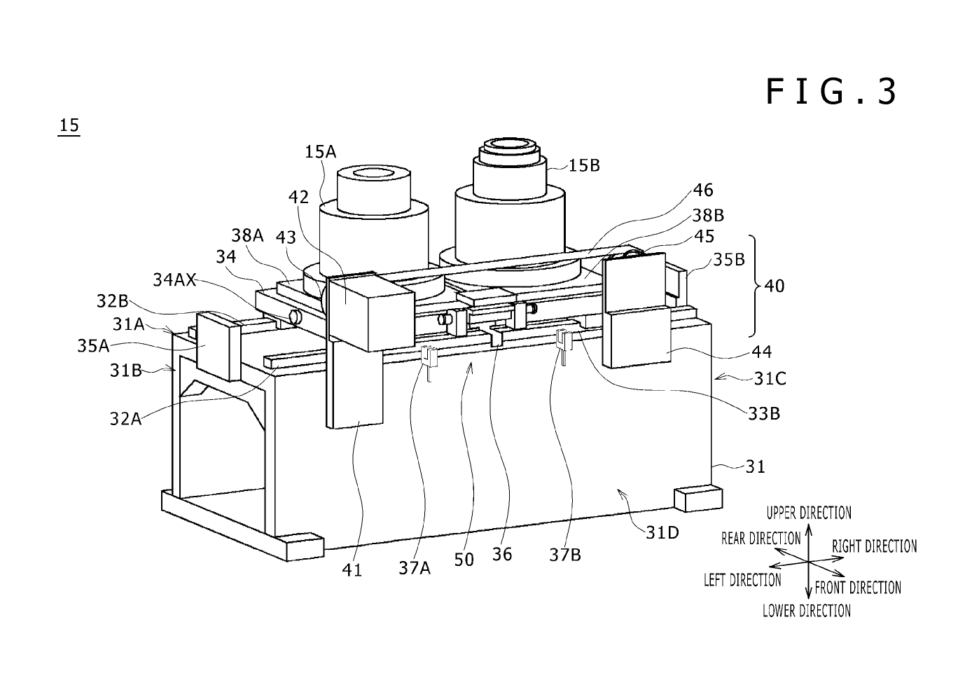

FIG. 3 is a perspective view illustrating only the lens barrel switching portion 15 extracted from the microscope system 1. Incidentally, for convenience of description, the side where the base 11, the stage portion 12 and the like (FIG. 1) are located is defined as the lower direction and the side where the imaging element 17B is located is defined as the upper direction in FIG. 3. In addition, the left direction, the right direction, the front direction and the rear direction are further defined based on the above.

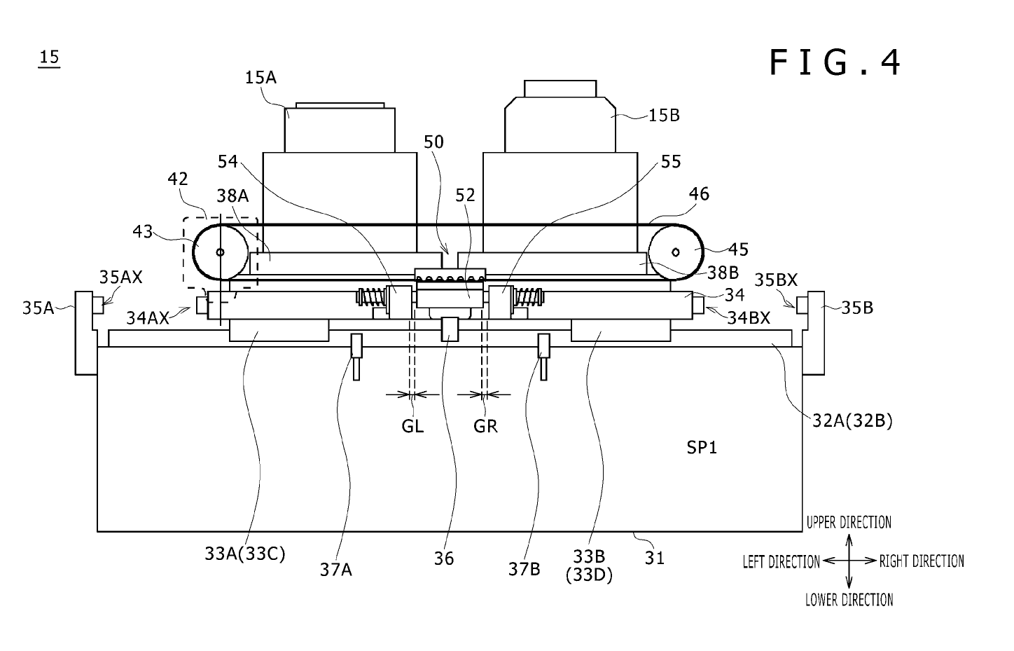

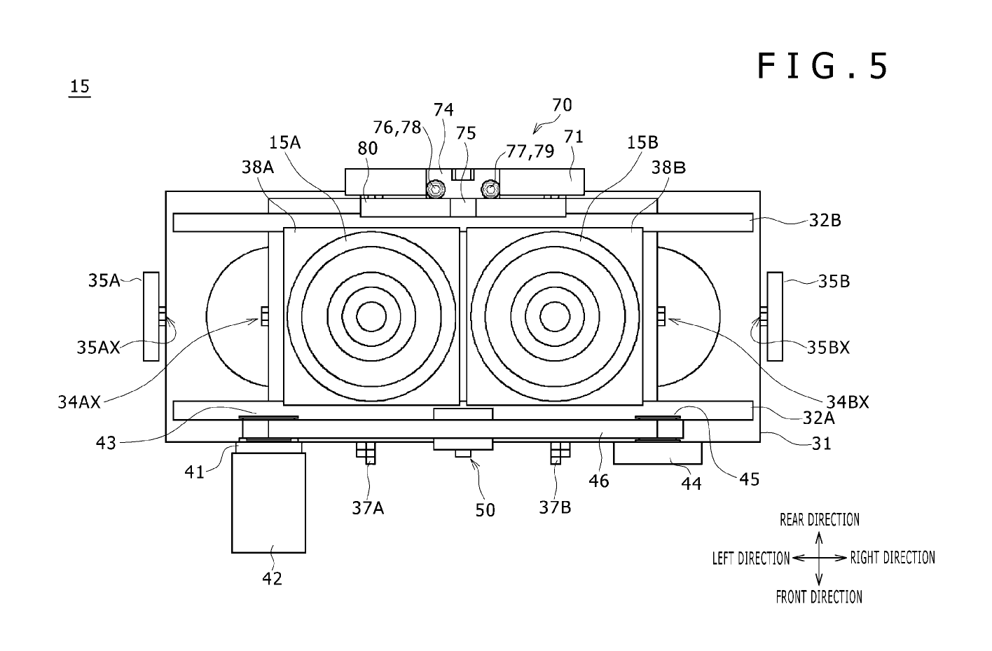

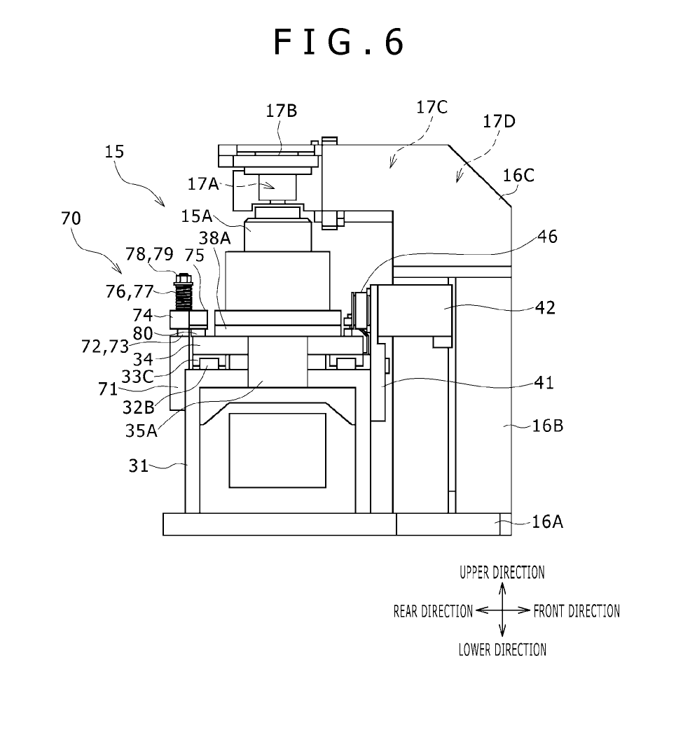

FIG. 4 is a front view of the lens barrel switching portion 15 as viewed from the front direction. FIG. 5 is a plan view as viewed from the upper direction. FIG. 6 is a left lateral view of the lens barrel switching portion 15 as viewed from the left direction. However, FIG. 4 illustrates the lens barrel switching portion 15 with their parts partially omitted. In addition, FIG. 6 illustrates also the imaging system holding portion 16 and the imaging portion 17 in addition to the lens barrel switching portion 15.

The parts of the lens barrel switching portion 15 are screwed; however, FIGS. 3 to 6 omit screws except portion thereof.

The lens barrel switching portion 15 is mainly composed of a lens barrel support portion 31. The lens barrel support portion 31 is formed in a hollow rectangular parallelepiped by fitting together and screwing a plurality of rectangular metal plates. The lower surface of the lens barrel switching portion 15 is screwed to the optical system holding portion 13 (FIG. 1).

Incidentally, the lens barrel switching portion 15 has left and right lateral surfaces which generally open, i.e., which are provided with respective large holes. In addition, the lens barrel switching portion 15 has front and rear plates which are provided with a plurality of large holes not illustrated. The lens barrel switching portion 15 is designed so that fluorescent lights, various optical filters, etc. can be installed in the inside thereof through these holes.

Rails 32A and 32B are mounted on an upper surface 31A of the lens barrel support portion 31 on the relatively front and rear sides, respectively, so as to be almost parallel to each other. In addition, the rails 32A, 32B extend from the vicinity of the left end portion to the vicinity of the right end portion. The rails 32A, 32B have almost the same shape and are each formed in an elongate quadratic prism.

A rectangular plate-like travel base 34 is installed above the rails 32A and 32B. Rail guides 33A and 33B are installed on the lower surface of the travel base 34 at respective left and right positions corresponding to the rail 32A. In addition, rail guides 33C and 33D are installed at respective left and right positions corresponding to the rail 32B.

The rail guides 33A, 33B, 33C, 33D have almost the same shape. The rail guides 33A, 33B, 33C, 33D are each formed almost in a rectangular parallelepiped shorter in a left-right direction and longer in an anteroposterior direction than the rails 32A, 32B. The rail guides 33A, 33B, 33C, 33D are formed on the lower surface thereof with respective grooves extending in the left-right direction. Each of the grooves has an anteroposterior width slightly greater than that of each of the rails 32A, 32B.

With such a configuration, the rail guides 33A, 33B, 33C, 33D can be slid in the left-right direction on the upper surfaces of the rails 32A, 32B with their grooves engaged with the associated rails 32A, 32B.

In short, the travel base 34 is designed to be movable in the left-right direction along the rails 32A, 32B.

Contact portions 34AX and 34BX each composed of a head portion of a hexagonal bolt are attached to the left lateral surface and right lateral surface, respectively, of the travel base 34. On the other hand, plate-like stoppers 35A and 35B are installed above the left lateral surface 31B and right lateral surface 31C, respectively, of the lens barrel support portion 31 so as to project upward from the upper surface 31A.

Position-defining portions 35AX and 35BX each composed of a head portion of a hexagonal bolt are attached to the respective stoppers 35A and 35B at respective positions corresponding to the contact portions 34AX and 34BX of the travel base.

With such a configuration, the travel range of the travel base 34 with respect to the lens barrel support portion 31 is defined in the left direction by the contact portion 34AX coming into contact with the position-defining portion 35AX. In addition, it is defined in the right direction by the contact portion 34BX coming into contact with the position-defining portion 35BX.

For convenience of description of the position of the travel base 34 in the following, the position where the contact portion 34AX comes into contact with the position-defining portion 35AX is called the left end. In addition, the position where the contact portion 34BX comes into contact with the position-defining portion 35BX is called the right end.

A sensor dog 36 formed by bending a plate-like member is attached to the central portion of the front surface of the travel base 34. The sensor dog 36 is shaped to extend forward from an attachment portion attached to the front surface of the travel base 34 and further extend downward from the front end portion thereof.

On the other hand, sensors 37A and 37B are attached to the left and right upper portions of the front surface 31D of the lens barrel support portion 31. The sensors 37A and 37B are each provided such that a light-emitting element and a light-receiving element are opposed to each other to have a gap therebetween. In addition, the sensors 37A and 37B detect the presence or absence of foreign matter in the gap and send a detection signal indicating its detection result to the control unit 3 (FIG. 1).

The sensor 37A is attached at such a position as to detect the sensor dog 36 immediately before the travel base 34 will reach the left end. In addition, the sensor 37B is attached at such a position as to detect the sensor dog 36 immediately before the travel base 34 will reach the right end.

With such a configuration, the control unit 3 can recognize that the travel base 34 is located at a position close to the left end or the right end on the basis of the detection signal from the sensor 37A or 37B, respectively.

The image forming lens 15A is attached to the left side of the upper surface of the travel base 34 via a rectangular plate-like lens table 38A. In addition, the image forming lens 15B is attached to the right side of the upper surface of the travel base 34 via a rectangular plate-like lens table 38B.

In other words, the travel base 34 and the image forming lenses 15A, 15B can travel along with and integrally with the rail guides 33A to 33D, the sensor dog 36 and the like in the right or left direction. In the following, these are collectively called a lens barrel traveling body 15M.

Incidentally, in the lens barrel switching portion 15, the position or the like of the contact portion 34AX and of the position-defining portion 35AX are adjusted so that the optical axis of the objective lens 14 may be aligned with that of the image forming lens 15B when the travel base 34 is shifted to the left end. In addition, the position or the like of the contact portion 34BX and of the position-defining portion 35BX are adjusted so that the optical axis of the objective lens 14 may be aligned with that of the image forming lens 15A when the travel base 34 is shifted to the right end.

A drive portion 40, which drives the travel base 34 in the right or left direction, is installed above the front surface 31D of the lens barrel support portion 31.

The drive portion 40 is generally designed such that a motor 42 generates power, which is transmitted to the travel base 34 via a belt 46.

The motor 42 is mounted above the left side of the front surface 31D of the lens barrel support portion 31 via an attachment plate 41 so that its output shaft may face the rear direction. A flat disklike pulley 43 is attached to the output shaft of the motor 42. The pulley 43 is formed with a gear on the circumferential surface thereof.

A flat disklike idler 45 is rotatably mounted above the right side of the front surface 31D of the lens barrel support portion 31 via an attachment plate 44. The rotating shaft of the idler 45 is almost parallel to the rotating shaft of the pulley 43, i.e., to the output shaft of the motor 42.

The annular belt 46 is wound between the pulley 43 and the idler 45 at such a tensional force that the annular belt 46 is not loose. The belt 46 is provided on the inside with grooves in meshing engagement with the gear formed on the circumferential surface of the pulley 43.

The motor 42 is a so-called stepping motor. Upon receipt of a pulse-like control signal, the motor 42 is rotated at rotating speed in accordance with the cycle of the pulse.

With such a configuration, if the motor 42 receives the pulse-like control signal from the control unit 3, the drive portion 40 rotates the pulley 43 at speed in accordance with the cycle of the pulse, so that the belt 46 circles between the pulley 43 and the idler 45 without slippage.

In the drive portion 40, the combination of the motor 42 and the pulley 43 provides the travel distance of the belt corresponding to one pulse of the control signal at approximately 200 μm. In other words, the drive portion 40 can move the belt 46 by approximately 200 μm, which is a unit travel distance.

A connecting portion 50 which transmits the drive force of the belt 46 to the central portion of the front surface of the travel base 34 is installed at the lower side of the belt 46.

As described later, the connecting portion 50 is designed to transmit the drive force applied to the belt 46, to the travel base 34 via an elastic member not directly.

The lens barrel switching portion 15 configured described above is such that shifting the travel base 34 to the left end or the right end can locate the image forming lens 15A or 15B, respectively, on the optical path extending from the slide glass SG on the stage 12 via the objective lens 14 to the imaging element 17B.

In this way, the microscope unit 2 can image the slide glass SG by use of the image forming lens 15A or 15B located on the optical path.

### 1-4. Configuration of the Connecting Portion

The connecting portion 50 is next described mainly with the perspective view of FIG. 7.

The connecting portion 50 includes an upper holding portion 51 and a lower holding portion 52 which hold the belt 46 from above and below; a shaft 53 passing through the lower holding portion 52 from side to side; a left securing portion 54 and a right securing portion 55 secured to the travel base 34 and sliding the shaft 53 from side to side; and coil springs 56, 57.

The upper holding portion 51 is formed like a flat plate. Grooves are formed repeatedly on the left-right direction on the lower surface of the upper holding portion 51 so as to extend in an anteroposterior direction.

The lower holding portion 52 is shaped such that a generally flat plate-like portion is vertically united with a rectangular parallelepipedic portion. The generally flat plate-like portion is similar to a flattened surface of the upper holding portion 51. The rectangular parallelepipedic portion is formed by compressing the flat plate-like portion anteroposteriorly and extending it vertically. In addition, the lower holding portion 52 is bored at the substantially center position with respect to upper-lower direction and left-right direction with a circular hole portion passing therethrough in the left-right direction.

The upper holding portion 51 is screwed to the lower holding portion 52 in the state where the lower portion of the belt 46 is put between the lower surface of the upper holding portion 51 and the upper surface of the lower holding portion 52.

The shaft 53 is formed in a columnar shape having a diameter slightly smaller than that of the hole portion of the lower holding portion 52. The shaft 53 is inserted through the hole portion and screwed to the lower holding portion 52 with the left and right projection lengths of the shaft 53 being generally equal to each other.

For convenience of the description in the following, a portion of the shaft 53 projecting leftward from the lower holding portion 52 is called a left shaft portion 53A. In addition, a portion of the shaft 53 projecting rightward from the lower holding portion 52 is called a right shaft portion 53B.

On the other hand, the left securing portion 54 is composed of a main portion 54A formed in a generally rectangular parallelepiped, and an projecting portion 54B installed at a rear lower portion of the left lateral surface of the main portion so as to project leftward therefrom. The main portion 54A is bored at a position above the center thereof with a hole portion 54H passing therethrough in the left-right direction. The hole portion 54H has a diameter slightly greater than that of the shaft 53.

The right securing portion 55 is formed symmetrically with the left securing portion 54 to have a hole portion 55H corresponding to the hole portion 54H.

The left securing portion 54 and the right securing portion 55 are secured to the front surface 34D of the travel base 34 with the left shaft portion 53A and the right shaft portion 53B inserted through the hole portions 54H and 55H, respectively.

With this, the left securing portion 54 and the right securing portion 55 travel leftward or rightward integrally with the travel base 34. In the following description, the lens barrel traveling body 15M includes also the left securing portion 54 and the right securing portion 55.

Incidentally, a distance between the right lateral surface of the left securing portion 54 and the left lateral surface of the right securing portion 55 is greater than the left-right length of the lower holding portion 52. In this way, a clearance GL is defined between the left securing portion 54 and the lower holding portion 52. In addition, a clearance GR is defined between the right securing portion 55 and the lower holding portion 52.

The coil spring 56 (FIG. 7) is spirally wound at a turn diameter slightly greater than the diameter of the shaft 53 and the diameter of the hole portion 54H and has elastic force. The natural length of the coil spring 56 is greater than that of a portion of the left shaft portion 53A projecting leftward from the left securing portion 54.

A retaining portion 58 is annularly formed to have an outer diameter greater than the turn diameter of the coil spring 56 and an inner diameter generally equal to the diameter of the shaft 53. The retaining portion 58 is secured to the vicinity of the left end of the left shaft portion 53A in the state where the coil spring 56 compressed in the left-right direction is inserted through the left shaft portion 53A projecting leftward from the left securing portion 54.

In this way, the coil spring 56 applies the elastic force (resilience) allowing itself to return to the natural length, between the left lateral surface of the left securing portion 54 and the right lateral surface of the retaining portion 58.

The coil spring 57 and a retaining portion 59 are formed similarly to the coil spring 56 and the retaining portion 58, respectively. The retaining portion 59 is secured to the vicinity of the right end of the right shaft 53B in the state where the coil spring 57 compressed in the left-right direction is inserted through the right shaft 53B projecting rightward from the right securing portion 55.

In this way, similarly to the coil spring 56, the coil spring 57 applies the elastic force (resilience) allowing itself to return to the natural length, between the right lateral surface of the right securing portion 55 and the left lateral surface of the retaining portion 59.

With such a configuration, in the connecting portion 50, the upper holding portion 51, the lower holding portion 52, the shaft 53, and the retaining portions 58, 59 are shifted in the left-right direction integrally with the belt 46. For the convenience of the description in the following, these are called a connection traveling body 50M.

That is to say, the connecting portion 50 transmits the drive force applied to the belt 46, from the connection traveling body 50M to the travel base 34 via the coil springs 56, 57 and further via the left securing portion 54 or the right securing portion 55.

### 1-5. Switching Operation of the Image Forming Lens

A description is next given of switching operation encountered when the lens barrel switching portion 15 switches between image forming lenses used in imaging processing, i.e., between the image forming lenses 15A and 15B.

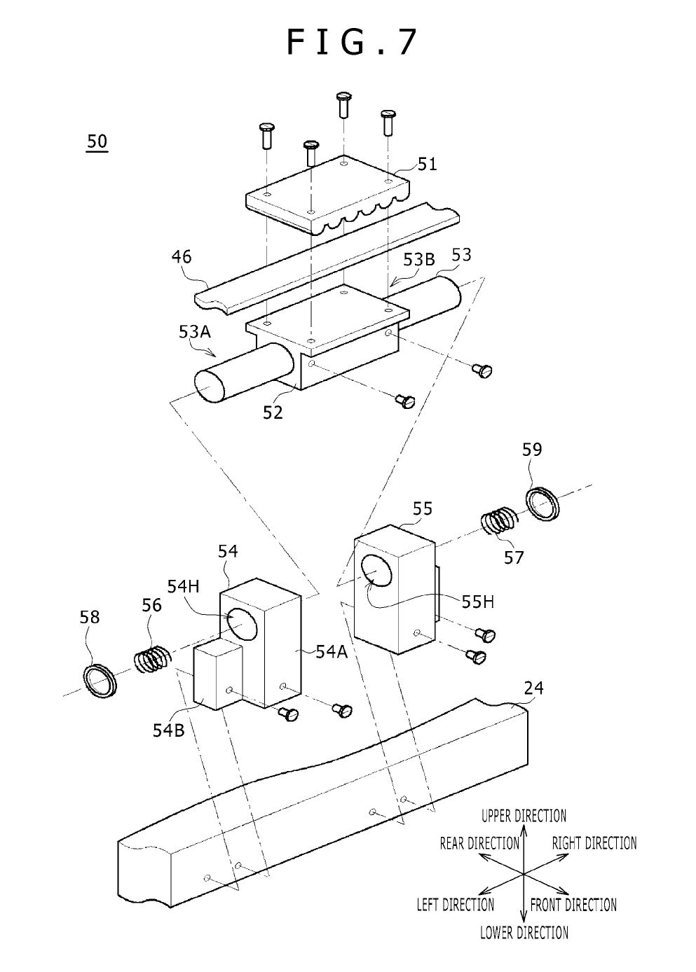

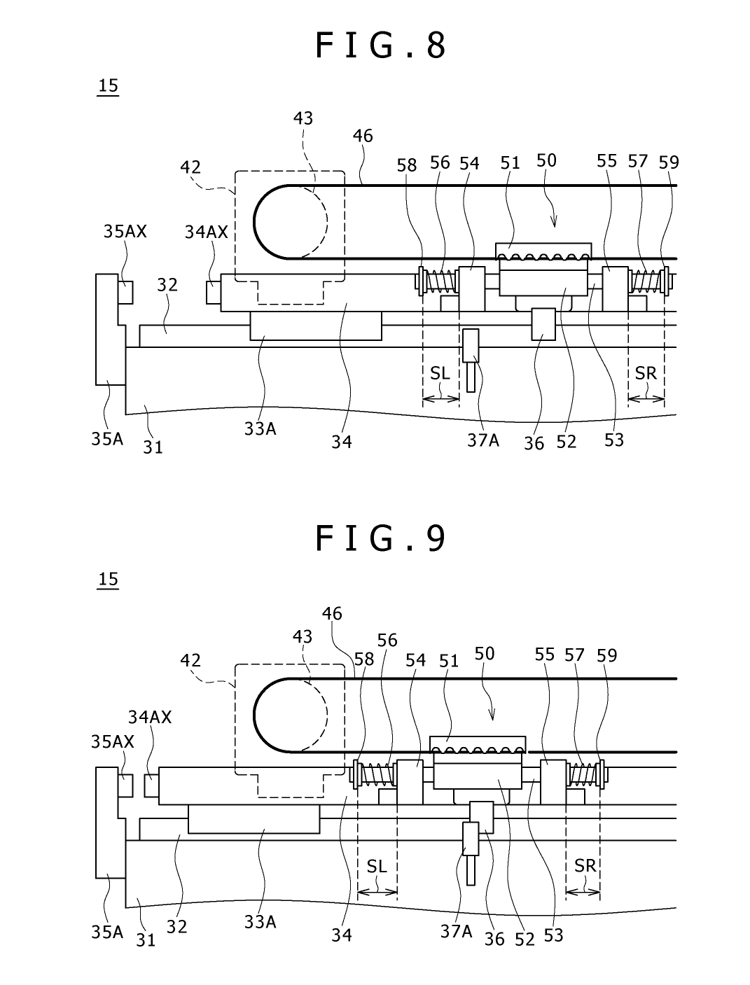

FIG. 8 illustrates an enlarged portion centering the connecting portion 50 of FIG. 4 with the parts thereof partially omitted. Referring to FIG. 8, it is assumed that the travel base 34 in the lens barrel switching portion 15 is located between the left end and the right end and no drive force is applied to the belt 46.

In this case, in the connecting portion 50, no force in the left-right direction is applied to the connection traveling body 50M (the upper holding portion 51, the lower holding portion 52, the shaft 53 and the retaining portions 58, 59). Therefore, the left and right coil springs 56, 57 are compressed by respective forces almost equal to each other, so that their coil lengths SL, SR are almost equal to each other.

Also in this case, the sensor dog 36 is located between the left and right sensors 37A, 37B so that it is not detected by any of them.

It is next assumed that the lens barrel switching portion 15 shifts the travel base 34 to the left end. In the lens barrel switching portion 15, the motor 42 receives a pulse-like control signal based on the control of the control unit 3 (FIG. 1) and transmits the clockwise drive force (i.e., the force driving the lower portion of the belt 46 leftward) to the belt 46 via the pulley 43.

In this case, in the connecting portion 50, a leftward drive force is applied to the connection traveling body 50M secured to the belt 46 and also to the retaining portion 59. This compresses the coil spring 57 and applies the resilience to the right lateral force of the right securing portion 55.

Similarly to a common spring, the coil spring 57 applies the resilience corresponding to the compressed length. Therefore, at the point of time when the resilience exceeds the static friction force of the lens barrel traveling body 15M, the lens barrel traveling body 15M starts to move leftward.

Incidentally, the cycle of the pulse of the control signal is relatively short; therefore, the lens barrel traveling body 15M travels leftward at a relatively high speed.

Thereafter, the lens barrel switching portion 15 advances the lens barrel traveling body 15M further leftward. At this time, the sensor dog 36 interrupts the gap of the sensor 37A, so that the sensor 37A detects the sensor dog 36. Incidentally, the contact portion 34AX of the lens barrel traveling body 15M is not in contact with the position-defining portion 35AX on the lens barrel support portion 31 side. In the following, the position of the lens barrel traveling body 15M at this time is referred to as the left sensor detection position.

In this case, the control unit 3 lengthens the cycle of the pulse of the control signal supplied to the motor 42 and limits the number of pulses supplied, to the given number (hereinafter, called the number of end micromotions). This further advances the lens barrel traveling body 15M leftward at a lowered traveling speed.

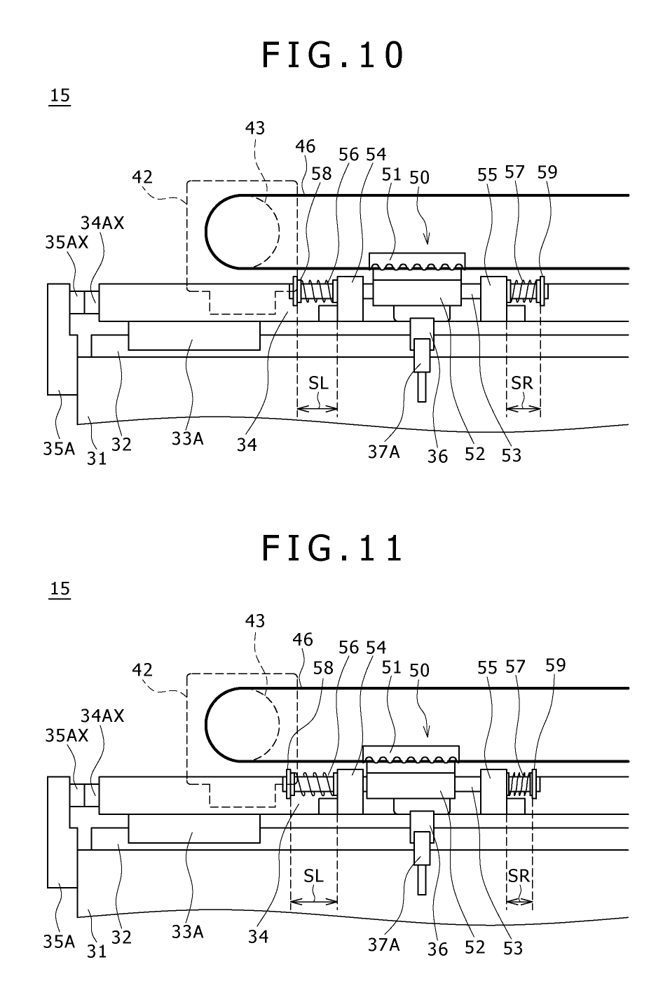

Thereafter, the lens barrel switching portion 15 further advances the lens barrel traveling body 15M leftward. As illustrated in FIG. 10, the lens barrel traveling body 15M reaches the left end position, so that the contact portion 34AX comes into contact with the position-defining portion 35AX.

Incidentally, the number of end micromotions is set at the number of pulses corresponding to a distance longer than a distance from the left sensor detecting position to the left end position. Specifically, the number of pulses corresponds to a distance longer than the travel distance of the lens barrel traveling body 15M until the contact portion 34AX is brought into contact with the position-defining portion 35AX after the sensor dog 36 is detected by the sensor 37A.

In this way, the control unit 3 continues to supply the pulses to the motor 42 also after the lens barrel traveling body 15M reaches the left end position. Thus, in the connecting portion 50, the retaining portion 59 of the connection traveling body 50M applies force from the right side of the coil spring 57.

On the other hand, the lens barrel traveling body 15M having already been located at the left end position cannot travel leftward even if receiving the leftward force applied thereto in this state. Therefore, the retaining portion 59 of the connection traveling body 50M compresses the coil spring 57 between the right securing portion 55 secured to the lens barrel traveling body 15M and the retaining portion 59 as illustrated in FIG. 11.

Therefore, the control unit 3 stops the supply of the pulses to the motor 42 when the number of pulses of the control signal reaches the number of end micromotions number after the sensor 37A detects the sensor dog 36.

At this time, in the connecting portion 50, the drive force vanishes which has been applied to the connection traveling body 50M from the belt 46. Therefore, the resilience of the coil spring 57 compressed until then by the drive force acts as below.

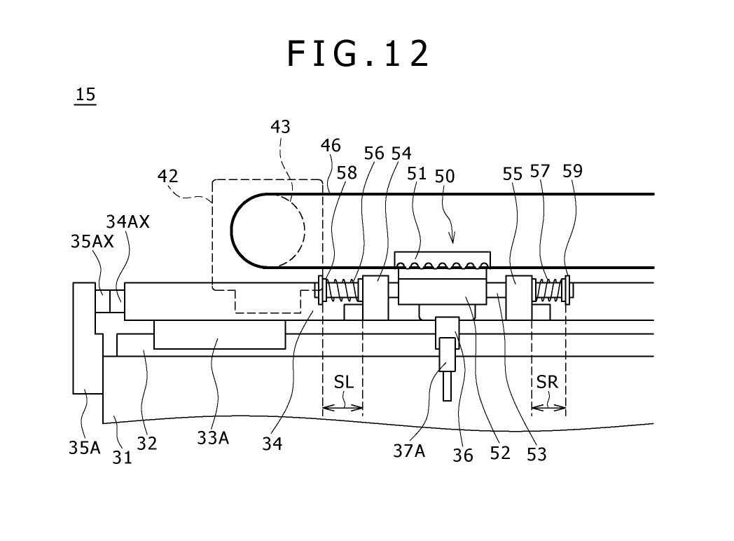

In this case, the coil spring 57 applies the resilience to the connection traveling body 50M rightward and to the lens barrel traveling body 15M leftward. As a result, the lens barrel traveling body 15M where the contact portion 34AX has already been in contact with the position-defining portion 35AX remains still. In addition, the connection traveling body 50M slightly travels rightward as illustrated in FIG. 12.

Incidentally, when being located at the left end position, the lens barrel traveling body 15M is brought into the state where a leftward pressing force is applied thereto, by the operation of a pressing portion 70 described later. In addition, also after the drive force of the motor 42 is blocked, the lens barrel traveling body 15M can keep the state of being located at the left end position.

In this way, after the lens barrel traveling body 15M is shifted leftward, the lens barrel switching portion 15 can be allowed to get still at the left end position.

Incidentally, the resilience applied to the coil springs 56, 57 and the compressed lengths of the coil springs 56, 57 have various restrictions because the coil springs 56, 57 perform a series of actions in the connecting portion 50. These restrictions are described below.

It is assumed that the number of pulse steps corresponding to one rotation of the motor 42 is P [step/rev]. In addition, the mass of the entire lens barrel traveling body 15M is M [kg]. A dynamic friction coefficient of the lens barrel traveling body 15M is μd. A static friction coefficient is μs. A spring constant of the coil springs 56 and 57 is k [N/m].

However, the connecting portion 50 is provided with the two coil springs 56 and 57; therefore, the spring constant k represents the spring constant of addition of the two coil springs 56 or 57, i.e., the twofold spring constant.

It is assumed that the stop torque of the motor 42 is Ts [Nm] and drive torque is Td [Nm]. In addition, the radius of the pulley 43 is r [m]. A gross loss factor of the pulley 43 is d (however, d<1.0). A travel distance encountered when the connection traveling body 50M is further pressed after the lens barrel traveling body 15M is located at any of the end portions is x [m].

Further, it is assumed that the bend elastic constant of each of the left securing portion 54 and the right securing portion 55 is S [N/m] and stop position accuracy is xs [m].

First, if the force applied to the left securing portion 54 and the right securing portion 55 is too strong in the connecting portion 50, then it bends the left securing portion 54 and the right securing portion 55. With that, the condition of allowing the left securing portion 54 and the right securing portion 55 not to bend is represented by expression (1) as below.

(k*x−μs*M)/S≧xs (1)

The left-right directional force applied from the connecting portion 50 when the lens barrel traveling body 15M is stopped at any of the left and right end positions involves the two conditions as below. First, the condition of maintaining the state of the coil springs 56 or 57 compressed by the stop torque of the motor 42 is represented by expression (2) as below.

k*x≦Ts*d*r (2)

Secondly, even if, after the stop of the motor 42, the connection traveling body 50M is returned (shifted in the opposite end direction) by one pulse at maximum by the resilience of the coil spring 56 or 57, the condition of maintaining the compressed state of the coil spring 56 or 57 is represented by expression (3) as below.

k*x>2*π*r/P (3)

The condition where during the traveling of the lens barrel traveling body 15M the coil spring 56 or 57 is not excessively compressed, e.g., the condition where the compression of the coil spring 56 or 57 is suppressed to one-fifth or less of the excessive travel distance x, is represented by expression (4) as below.

k*x/5≧Td*d*r−μd*M (4)

In this way, the lens barrel switching portion 15 is designed to satisfy expressions (1) to (4).

### [1-6. Image Forming Lens Switching Processing Procedure]

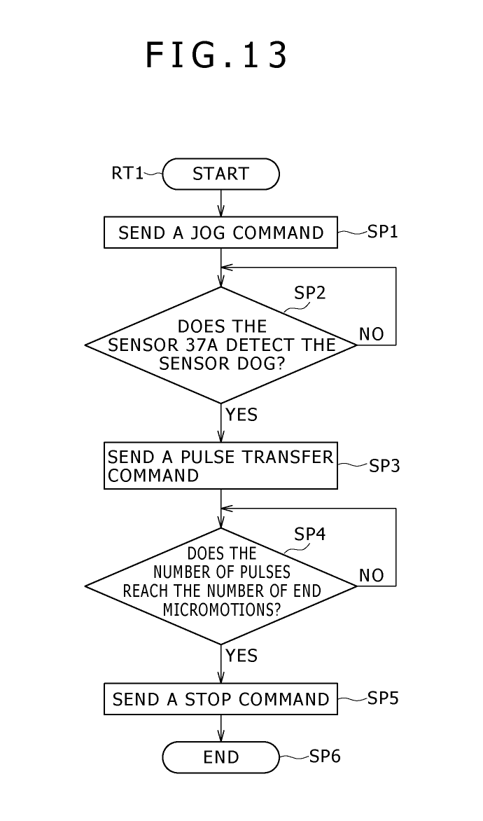

An image forming lens switching processing procedure is next described with reference to a flowchart of FIG. 13. This procedure is performed when the control unit 3 switches between the image forming lenses 15A and 15B by shifting the lens barrel traveling body 15M of the lens barrel switching portion 15 from one end or an intermediate position to the other end.

Incidentally, a description is below given of the case where the lens barrel traveling body 15M is shifted to the left end by way of example.

Following a user's operative command and the command of the preset schedule program or the like, the control section 21 of the control unit 3 reads an image forming lens switching program from the storage section 23 and starts routine RT1 and the processing proceeds to step SP1.

In step SP1, the control section 21 starts to send a jog command composed of pulses of a relatively short cycle to the motor 42 and the processing shifts to the next step SP2.

In response to this, during the receipt of the jog command, the motor 42 permits the belt 46 to circle at a relatively high speed to shift the lens barrel traveling body 15M leftward via the connecting portion 50.

In step SP2, the control section 21 determines whether or not the sensor 37A detects the sensor dog 36. The determination may be negative. This means that the lens barrel traveling body 15M does not yet reach the left sensor detecting position (FIG. 8) and it is subsequently necessary to shift the lens barrel traveling body 15M leftward. In this case, the control section 21 repeats step SP2 and waits for detection of the sensor dog 36.

On the other hand, in step SP2, the determination may be affirmative. This means that the lens barrel traveling body 15M reaches the left sensor detection position (FIG. 9) and it is necessary to stop the lens barrel traveling body 15M at the left end. In this case, the processing in the control section 21 shifts to the next step SP3.

In step SP3, the control section 21 starts to send a pulse transfer command composed of pulses of a relatively long cycle to the motor 42 and to count the number of the pulses. The processing in the control section 21 shifts to the next step SP4.

In response to this, during the reception of the pulse transfer command, the motor 42 allows the belt 46 to circle to slowly shift the lens barrel traveling body 15M leftward via the connecting portion 50.

In step SP4, the control section 21 determines whether or not the number of pulses reaches the number of end micromotions after the start of the pulse transfer command. If the determination is negative, the control section 21 repeats step SP4 while continuing the transmission of the pulse transfer command.

In this case, also after the contact portion 34AX comes into contact with the position-defining portion 35AX, i.e., the lens barrel traveling body 15M reaches the left end (FIG. 10), the motor 42 continues to apply the drive force to the belt 46 following the pulse transfer command. In addition, the belt 46 presses the connection traveling body 50M leftward while compressing the coil spring 57 (FIG. 11).

On the other hand, the determination is affirmative in step SP4. This means that the number of pulses after the start of the pulse transfer command reaches the number of end micromotions. In this case, the processing in the control section 21 shifts to the next step SP5.

In step SP5, the control section 21 stops the transfer of the pulse transfer command and sends a stop command to the motor 42. Thereafter, the processing in the control section 21 shifts to step SP6 and ends routine RT1.

In this case, the motor 42 stops the application of the drive force to the belt 46. In response to this, the connection traveling body 50M is slightly shifted rightward by the resilience of the coil spring 57 (FIG. 12). However, the lens barrel traveling body 15M maintains the resting state at the left end position.

Consequently, the control section 21 can accurately locate the lens barrel traveling body 15M at the left end position.

### 1-7. Configuration of the Pressing Portion

A description is next given of the pressing portion 70 pressing the lens barrel traveling body 15M leftward or rightward.

As illustrated in FIGS. 5 and 6, the pressing portion 70 is installed to be spanned from a rear-surface upper portion of the lens barrel support portion 31 to a rear portion of the travel base 34.

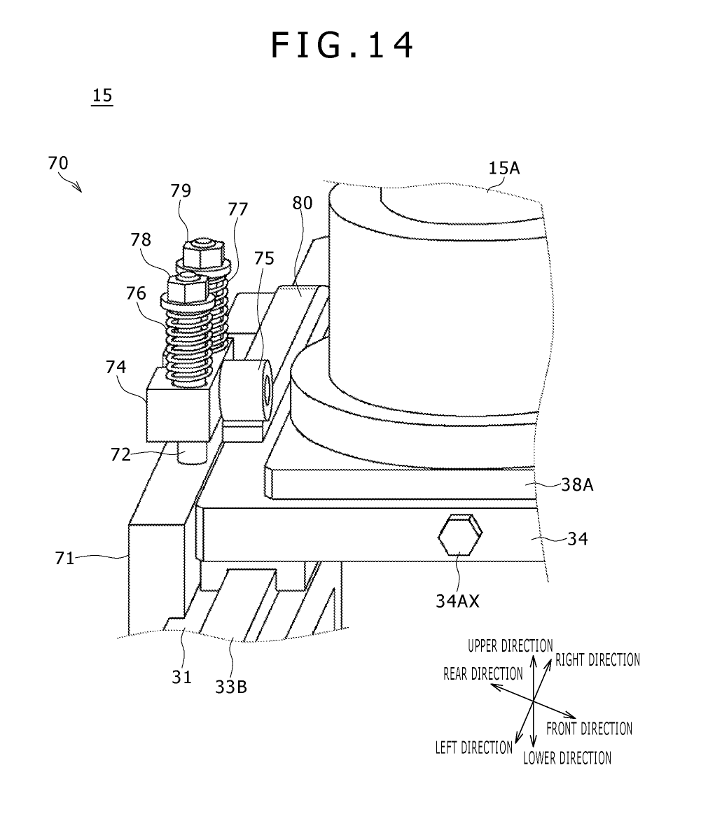

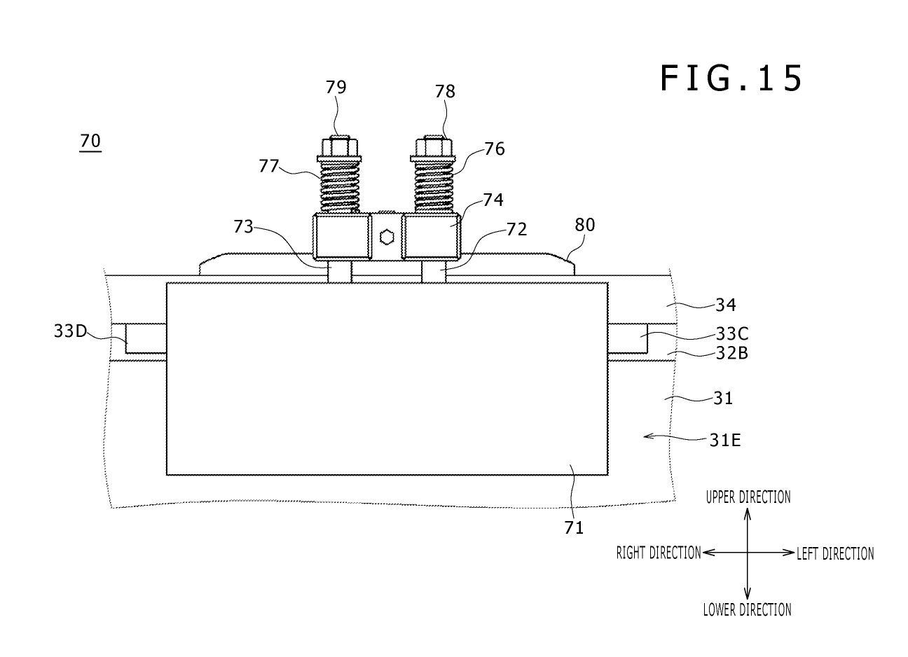

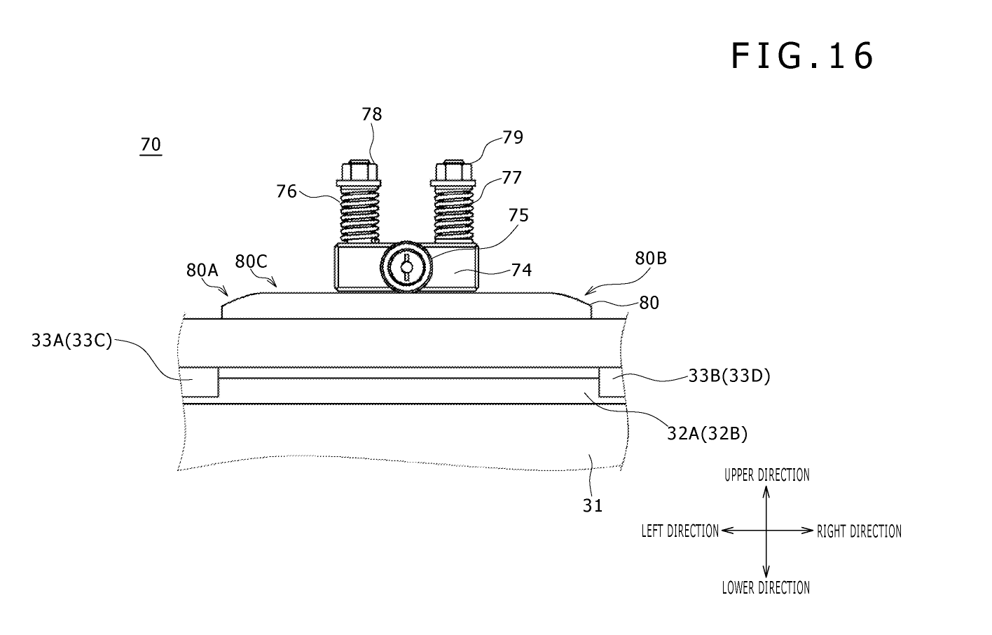

FIG. 14 is a perspective view of the pressing portion 70 as viewed from above on the left-rear side. FIG. 15 is a rear view of the pressing portion 70. FIG. 16 is a front view of the pressing portion 70. Incidentally, in FIGS. 15 and 16, the image forming lenses 15A, 15B, the lens tables 38A, 38B, and the drive portion 40 are omitted.

The pressing portion 70 is mainly composed of a portion mounted to the lens barrel support portion 31 via an attachment plate 71 and a cam guide 80 mounted to the travel base 34.

The attachment plate 71 is formed in a rectangular parallelepiped elongate right and left and thin back and forth and is mounted to a horizontally central upper portion of a rear surface 31E of the lens barrel support portion 31.

Generally columnar guide shafts 72, 73 are installed on the upper surface of the attachment plate 71 so as to project upward at respective positions slightly horizontally offset from the horizontal center.

A cam block 74 is formed in a generally rectangular parallelepiped. In addition, the cam block 74 is bored with insertion holes at respective positions corresponding to the guide shafts 72, 73. The insertion holes vertically pass through the cam block 74 and have a diameter slightly larger than that of each of the guide shafts 72, 73.

Further, a generally columnar cam 75 is rotatably attached to the front surface of the cam block 74 at almost the center thereof.

In actuality, in the state where the guide shafts 72, 73 are inserted through the two corresponding insertion holes, the cam block 74 is vertically shifted to vertically shift the cam 75.

Coil springs 76, 77 have a turn diameter slightly greater than the diameter of each of the guide shafts 72, 73, are spirally wound around the respective guide shafts 72, 73, and have an elastic force. The natural lengths of the coil springs 76, 77 are set longer than a portion, projecting upwardly from the cam block 74, of each of the guide shafts 72, 73.

Retaining portions 78 and 79 have respective outer diameters greater than the turn diameters of the coil springs 76 and 77, respectively. In addition, the retaining portions 78 and 79 have respective inner diameters almost equal to the respective shaft diameters of the guide shafts 72 and 73.

In actuality, the retaining portions 78 and 79 are secured to the corresponding upper end portions of the guide shafts 72 and 73 passing through the cam block 74 and the respective coil springs 76 and 77.

In this case, each of the coil springs 76, 77 has a vertically acting resilience because of being brought into a compressed state.

On the other hand, the cam guide 80 is mounted in rear of the upper surface of the travel base 34 so as to correspond to the cam 75. The cam guide 80 is formed in a horizontally elongate quadrangular prism similarly to the rails 32A, 32B. The cam guide 80 has a horizontal length slightly greater than an inter-lens distance, which is a distance between the respective centers of the image forming lenses 15A, 15B as shown in FIG. 5.

As illustrated in FIGS. 15 and 16, slant portions 80A, 80B are provided on the upper surface of the cam guide 80 at respective portions close to the corresponding left and right ends so as to slant downward as they go toward the corresponding end sides. Incidentally, a central flat portion of the upper surface of the cam guide 80 excluding the slant portions 80A, 80B is called a flat portion 80C in the following.

With such a configuration, the pressing portion 70 presses the cam 75 to the upper surface of the cam guide 80 via the cam block 74 through the action of the resilience (hereinafter, called the pressing force F) of coil springs 76, 77.

The cam guide 80 is shifted leftward or rightward integrally with the lens barrel traveling body 15M including the travel base 34. On the other hand, the cam 75 is secured to the lens barrel support portion 31 with respect to the left-right direction.

The pressing portion 70 is configured as described above. If the lens barrel traveling body 15M is located close to the left or right end position, therefore, the cam 75 comes into contact with the slant portion 80B or 80A of the cam guide 80. If the lens barrel traveling body 15M is not located close to the left or right end position, the cam 75 comes into contact with the flat portion 80C.

Incidentally, the direction and magnitude of the pressing force F applied from the cam 75 to the cam guide 80 vary depending on an inclination angle at a position where the cam 75 comes into contact with the cam guide 80.

The pressing force F acting downward from the cam 75 on the cam guide 80 is represented by expression (5) as below, where the spring constant of each of the coil springs 76, 77 is k, and the length of each of the coil springs 76, 77 compressed from its natural length is y.

F=2*k*y (5)

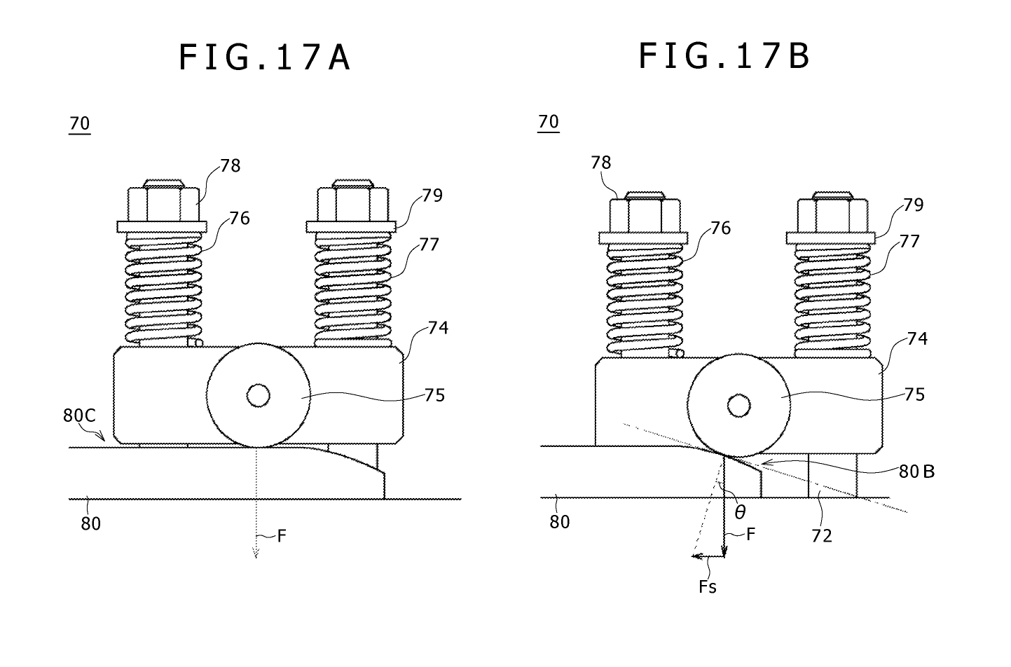

As illustrated in FIG. 17A which is a partial enlarged view of FIG. 16, if the cam 75 is in contact with the flat portion 80C of the cam guide 80, the pressing force F acts almost immediately below but does not almost act in the left-right direction.

On the other hand, as illustrated in FIG. 17B, the cam 75 may be in contact with the slant portion 80B of the cam guide 80. In such a case, if the inclination angle of the slant portion 80B is assumed as θ, a horizontally pressing force Fs (=F·tan θ) occurs which is a horizontal drag acting leftward with respect to the pressing force F acting immediately below.

In other words, if the lens barrel traveling body 15M is located close to the left end position, the cam 75 of the pressing portion 70 applies the horizontal pressing force Fs leftward to the lens barrel traveling body 15M via the slant portion 80B of the cam guide 80.

Incidentally, if the cam 75 is in contact with the slant portion 80A, the action of the pressing force F of the cam 75 is symmetrical with respect to that in FIG. 17B.

Specifically, if the lens barrel traveling body 15M is located close to the right end position, the cam 75 of the pressing portion 70 applies the horizontal pressing force Fs rightward to the lens barrel traveling body 15M via the slant portion 80A of the cam guide 80.

The condition where the horizontal pressing force Fs allows the lens barrel traveling body 15M to get still at any of the left and right end positions is represented by expression (6) as below, by use of the mass M of the entire lens barrel traveling body 15M and a static friction coefficient μs.

Fs>M*μs (6)

In actuality, the pressing portion 70 is configured such that the inclination angle θ of the slant portion 80A or 80B is determined to satisfy expression (6).

In this way, the pressing portion 70 is designed to allow the horizontal pressing force Fs to act to further press the lens barrel traveling body 15M to the left end or the right end, only when the lens barrel body 15M is located close to the left end position or to the right end position.

### 1-8. Operation and Effects

In the configuration described above, the connecting portion 50 of the lens barrel switching portion 15 shifts the lens barrel traveling body 15M to the left end position. In addition, also even after the lens barrel traveling body 15M reaches the left end position, the leftward drive force transmitted from the motor 42 via the belt 46 is absorbed by the elastic force of the coil spring 57.

Thereafter, if the drive force transmitted from the motor 42 via the belt 46 is blocked, the connection traveling body 50M is slightly returned rightward by the resilience of the coil spring 57. However, the connecting portion 50 allows the lens barrel traveling body 15M to remain still at the left end position, i.e., not to be shifted.

Specifically, the control section 21 controls the cycle and number of the pulses supplied to the motor 42 so as to cause such an excess drive force as to slightly exceed the travel distance of the lens barrel traveling body 15M from the left sensor detection position to the left end position. Even this can bring the contact portion 34AX of the lens barrel traveling body 15M into contact with the position-defining portion 35AX.

In this case, the connecting portion 50 can absorb the excessive drive force through the elastic action of the coil spring 57. Therefore, while preventing damage resulting from an excessive load or the like of the motor 42, the connecting portion 50 can maintain the state where the lens barrel traveling body 15M is allowed to get still at the left end position.

Since the unit travel distance of the motor 42 is approximately 200 μm, the lens barrel switching portion 15 cannot be always precisely regulated in position. In addition, also the lens barrel traveling body 15M cannot be detected in left-right directional position at a high degree of accuracy.

However, because of the combination of the sensor dog 36 and the sensors 37A, 37B, the lens barrel switching portion 15 can allow the control section 21 to recognize that the lens barrel traveling body 15M is at the left sensor detection position (FIG. 9).

Thus, the control section 21 can allow the lens barrel traveling body 15M to coincide with the left end position at a high degree of accuracy only by the following. That is to say, based on the fact that the connecting portion 50 can absorb the excessive drive force, the lens barrel traveling body 15M can excessively be shifted in such a degree as to exceed the distance from the left sensor detection position to the left end position.

Further, when pulses are supplied to the motor 42 to allow the belt 46 to start to circle, the coil spring 56 or 57 in the connecting portion 50 is first compressed to cause resilience. This resilience may exceed the static friction force of the lens barrel traveling body 15M. At this time, the lens barrel traveling body 15M is first shifted. Thus, the connecting portion 50 can prevent a drive force (an accelerating force) from being suddenly applied to the image forming lens 15A or 15B of the lens barrel traveling body 15M. That is to say, the connection portion 50 can allow the image forming lens 15A or 15B to start to shift moderately.

The lens barrel switching portion 15 is such that the slant portions 80A and 80B are provided close, respectively, to the left and right ends on the upper surface of the cam guide 80 in the pressing portion 70. In addition, the other portion on the upper surface of the cam guide 80 is formed as the flat portion 80C. The resilience of the coil springs 76, 77 presses the cam block 74 and the cam 75 downwardly.

When the cam 75 is located close to the left or right end of the cam guide 80, the pressing portion 70 applies the horizontal pressing force Fs to the slant portion 80A or 80B. In this way, only when the lens barrel traveling body 15M is close to any of the left and right ends, the pressing portion 70 can press the lens barrel traveling body 15M toward the corresponding end (FIG. 17B).

Thus, the pressing portion 70 can allow the lens barrel traveling body 15M to continuously get still at the left or right end position also when the lens barrel traveling body 15M reaches the left or right end position and the drive force from the motor 42 is blocked so that the resilience of the coil spring 56 or 57 of the connecting portion 50 acts.

Further, when the lens barrel traveling body 15M is at a position other than the left and right ends, i.e., when the cam 75 is brought into contact with the flat portion 80C of the cam guide 80, the pressing portion 70 applies the pressing force F downward (FIG. 17A).

Thus, during the traveling of the lens barrel traveling body 15M, the pressing portion 70 allows the horizontal pressing force Fs not to hinder the drive force and can enhance adhesion between the rails 32A, 32B and the corresponding rail guides 33A to 33D.

Consequently, even if the drive force generated by the motor 42 is nonconstant, i.e., varies, the pressing force 70 can prevent the occurrence of the unnecessary vibration of the lens barrel traveling body 15M.

The microscope unit 2 is such that the imaging portion 17 having the imaging element 17B and the like is separated from the lens barrel switching portion 15 and is held by the staunch imaging-system holding portion 16 mounted to the optical system holding portion 13.

In particular, the microscopic unit 2 images the slide glass SG on a part-by-part basis and combines the parts of the image. The position gap between optical elements may occur due to vibrations or the like from the stage portion 12 (FIG. 1) after the start of imaging. In such a case, therefore, a problem in that the normal combination cannot be done or the like is likely to occur.

In this regard, the microscope unit 2 can increase the positional accuracy of the imaging portion 17 compared with the case in which the relatively heavy imaging portion 17 is directly mounted to the image forming lenses 15A, 15B which may cause the error of the positional accuracy due to a movable mechanism of the lens barrel switching portion 15.

With the configuration described above, the connecting portion 50 of the lens barrel switching portion 15 shifts the lens barrel traveling body 15M to the left end position. In addition, the leftward drive force transmitted from the motor 42 via the belt 46 even after the lens barrel traveling body 15M reaches the left end position is absorbed by the elastic force of the coil spring 57. Thereafter, if the drive force transmitted from the motor 42 via the belt 46 is blocked, the connection traveling body 50M is slightly returned rightward by the resilience of the coil spring 57. However, the connecting portion 50 allows the lens barrel traveling body 15M to remain still at the left end position, i.e., not to be shifted. In this way, the lens barrel switching portion 15 allows the connecting portion 50 to absorb the excess drive force. Thus, the lens barrel traveling body 15M can be allowed to get still at the left end position extremely accurately by maintaining the state where the contact portion 34AX is brought into contact with the position-defining portion 35AX.

### Other Embodiments

Incidentally, the above embodiment describes the case where the combination of the connection traveling body 50M, the coil springs 56, 57 and the left and right securing portions 54, 55 constitutes the connecting portion 50 as illustrated in FIG. 7.

The present disclosure is not limited to this. A combination of various parts may constitute the connecting portion 50. In this case, the point is that the drive force transmitted from the belt 46 needs only to be transmitted to the lens barrel traveling body 15M via an elastic body with an elastic force and to satisfy expressions (1) through (4).

The above embodiment describes the case where in the drive portion 40 the combination of the pulley 43, the idler 45 and the belt 46 transmits the power of the motor 42 to the connecting portion 50.

The present disclosure is not limited to this. For example, a combination of worm gears, threaded shafts, etc. and various gears, racks, etc. or ball screws or other transmitting mechanisms may transmit the power of the motor 42 to the connecting portion 50.

Further, the above embodiment describes the case where the motor 42 is a stepping motor.

The present disclosure is not limited to this. The motor 42 may be a variety of other types of motors. The point is that based on the control of the control unit 3 the belt 46 can be circled in a desired direction at a desired circling speed by a given unit travel distance. In this case, even if the travel distance of the belt 46 can be controlled only stepwise, the compression length of the coil spring 56 or 57 in the connecting portion 50 needs only to be longer than the minimum travel distance of the belt 46.

The above embodiment describes the case where the combination of the sensor dog 36 and the sensors 37A, 37B can detect that the lens barrel traveling body 15M is at the left sensor detection position or the like.

The present disclosure is not limited to this. For example, a contact-type sensor, a distance sensor or the like may be used to detect the position of the lens barrel traveling body 15M. Further, the configuration without the provision of sensors may be acceptable. The point is that it is only needed to be able to supply, from the motor 42 via the connecting portion 50, a drive force equal to or greater than that capable of shifting the lens barrel traveling body 15M to the left or right end position.

The above embodiment describes the case where when the lens barrel traveling body 15 is at the left or right end position, the pressing portion 70 applies the horizontal pressing force Fs in the left or right direction.

However, the present disclosure is not limited to this. The following may be acceptable. For example, the lens barrel traveling body 15M reaches the left or right end position and the number of pulses supplied to the motor 42 reaches the number of end micromotions. Thereafter, the state where the coil spring 57 is compressed (FIG. 11) is maintained by allowing the motor 42 to produce sufficient torque for stillness. Alternatively, only when a variety of mechanisms allows the lens barrel traveling body 15M to reach the left or right end position, the belt 46 may be held. In this case, the action of the resilience of the belt 46 getting still and of the coil spring 57 can generate the leftward pressing force against the lens barrel transmitting body 15M.

Further, if having a sufficiently large static friction coefficient, the lens barrel traveling body 15M is allowed to get still at the left or right end position only by the static friction force without the application of the leftward or rightward pressing force to the lens barrel traveling body 15M.

The above embodiment describes the case where the motor of the drive portion 40 is secured on the lens barrel support portion 31 side and the drive force of the motor is transmitted to the lens barrel traveling body 15M via the connecting portion 50 to shift it.

The present disclosure is not limited to this. The following may be acceptable. For example, the motor of the drive portion 40 may be secured to the lens barrel traveling body 15M side. In addition, the drive force of the motor may be transmitted to the lens barrel support portion 31 side via the connecting portion 50 to shift the lens barrel traveling body 15M.

The above embodiment describes the case where the cam 75 and like in the pressing portion 70 is mounted to the lens barrel support portion 31 side and the cam guide 80 is mounted to the upper surface of the travel base 24 in the lens barrel travel body 15M.

The present disclosure is not limited to this. For example, the cam 75 and the like may be mounted to the lens barrel traveling body 15M side and the cam guide 80 may be mounted to the lens barrel support portion 31 side. Specifically, the cam 75 and the like may be installed in the state where, for example, the guide shafts 72, 73 project downward, i.e., are inverted. In addition, the cam guide 80 may be mounted to the lens barrel support portion 31 so that the slant portions 80A, 80B and the flat portion 80C are formed on the bottom surface of the cam guide 80.

In this case, the point is the following. A pressed-object (the lens barrel support portion 31 in this case or the lens barrel traveling body 15M in the embodiment) may be pressed via the cam guide 80 against the object (the lens barrel traveling body 15M in this case or the lens barrel support portion 31 in the embodiment) supported by the guide shafts 72, 73 by the pressing force F of the cam 75.

The above embodiment describes the case where only one pressing portion 70 is installed on the rear side of the lens barrel support portion 31.

The present disclosure is not limited to this. For example, the pressing portion 70 may be installed on the front surface side. Alternatively, two or more sets of the pressing portions 70 may be installed on the front and rear sides of the lens barrel support portion 31.

The above embodiment describes the case where the rails 32A, 32B are installed to extend in the left-right direction and the rail guides 33A to 33D are engaged with and slid along the corresponding rails 32A, 32B. In this way, the lens barrel traveling body 15M is shifted in the left-right direction with respect to the lens barrel support portion 21.

The present disclosure is not limited to this. The lens barrel traveling body 15M may be allowed to travel in the left-right direction with respect to the lens barrel support portion 21 by a variety of travel mechanisms, such as a combination of grooves extending in a left-right direction and corresponding projections sliding in the associated grooves.

The above embodiment describes the case where the objective lens 14 of the microscope unit 2 is secured and the two types of image forming lenses 15A, 15B are switched by the lens barrel switching portion 15.

The present disclosure is not limited to this. The lens barrel switching portion 15 is used, for example, when the image forming lens is secured and object lenses of two types different in magnification from each other are switched therebetween. In this manner, the lens barrel switching portion 15 may be used when various optical elements are switched therebetween.

The above embodiment describes the following case. The two image forming lenses 15A, 15B are disposed in the left-right direction on the travel base 34. The image forming lenses 15A, 15B are switched therebetween by allowing the drive portion 40 of the lens barrel switching portion 15 to shift the lens barrel travel body 15M in the left-right direction.

The present disclosure is not limited to this. For example, four image forming lenses may be switched therebetween by a combination of e.g. two sets of the drive portions 40. More specifically, four image forming lenses are disposed on the travel base 34 such that two of them are disposed right and left and the other two are disposed back and forth. An intermediate travel base is further installed between the travel base and the lens barrel support portion 31 and two sets of the drive portions 40 are installed. A first drive portion 40 shifts the intermediate travel base in the left-right direction with respect to the lens barrel support portion 31. A second drive portion shifts the travel base 34 in the anteroposterior direction with respect to the intermediate travel base.

The above embodiment describes the following case. The microscope system 1 as an optical element switching apparatus is composed of the lens barrel support portion 31 as a main body portion, the lens barrel traveling body 15M as a traveling body portion, the rails 32A, 32B and the rail guides 33A, 33B, 33C, 33D as a shifting portion, position-defining portions 35AX, 35BX as a travel limit position-defining portion, the motor 42 as a drive force generating portion, the connecting portion 50 as a connecting portion, the pressing portion 70 as a holding portion, and the control unit 3 as a control portion.

However, the present disclosure is not limited to this. An optical element switching apparatus may be composed of a main body portion, a travel body portion, a shifting portion, a travel limit position-defining portion, a drive force generating portion, a connecting portion, a holding portion and a control portion configured in other various ways.

The above embodiment describes the following case. The microscope system 1 as an optical element switching apparatus is composed of the lens barrel support portion 31 as a main body portion, the imaging element 17B as an imaging element, the lens barrel traveling body 15M as a traveling body portion, the rails 32A, 32B and the rail guides 33A, 33B, 33C, 33D as a shifting portion, position-defining portions 35AX, 35BX as a travel limit position-defining portion, the motor 42 as a drive force generating portion, the connecting portion 50 as a connecting portion, the pressing portion 70 as a holding portion, and the control unit 3 as a control portion.

However, the present disclosure is not limited to this. A main body portion, a imaging element, a traveling body portion, a shifting portion, a travel limit position-defining portion, a drive force generating portion, a connecting portion, a holding portion and a control portion configured in other various ways may constitute an optical element switching apparatus.

The present disclosure is usable in various optical apparatuses in which optical elements are installed in an optical path, such as microscopes and imaging apparatuses configured in various ways.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An optical element switching apparatus comprising:
a main body portion in which an optical path is set;
a traveling body portion on which two types of optical elements are mounted;
a shifting portion adapted to shift the traveling body portion with respect to the main body portion so that an optical axis of any one of the optical elements is aligned with the optical axis of the optical path by shifting any one of the optical axes of the two types of optical elements on a predetermined travel line;
a travel limit position defining portion adapted to define a travel limit position of the traveling body portion with respect to the main body portion, in relation to each of a first direction along the travel line and a second direction opposite to the first direction;
a drive force generating portion generating a drive force adapted to shift the traveling body portion in one of the first and second directions by a predetermined unit travel distance and transmitting the drive force to a predetermined transmission portion;
a connecting portion connecting the transmitting portion with the traveling body portion via a predetermined elastic body and displacing the traveling body portion with respect to the transmitting portion in each of the first and second directions within a range of an elastic displacement width greater than the unit travel distance;
a holding portion applying a force greater than an elastic force occurring in the connecting portion to the traveling body portion shifted to the travel limit position, in a direction opposite to the direction where the elastic force acts, so as to hold the traveling body portion at the travel limit position; and
a control portion adapted to control the drive force generating portion to supply a drive force capable of shifting the traveling body portion farther than the travel limit position when the traveling body portion is to be shifted.

2. The optical element switching apparatus according to claim 1, further comprising:
a sensor detecting that the traveling body portion is located close to the travel limit position;
wherein, after the sensor detects that traveling body portion is close to the travel limit position, the control portion controls the drive force generating portion so as to be able to shift the traveling body portion by a distance farther than the travel limit position.

3. The optical element switching apparatus according to claim 1,
wherein the drive power generating portion is a stepping motor, and
the transmitting portion is a belt adapted to receive the drive force transmitted via a pulley attached to an output shaft of the stepping motor.

4. The optical element switching apparatus according to claim 3,
wherein the stepping motor is secured to the main body portion, and
the connecting portion includes
a belt side secured portion secured to portion of the belt,
first and second shaft portions attached to the belt side secured portion and extended in the first and second directions, respectively,
first and second traveling body portion side secured portions attached on the first and second direction sides, respectively, of the belt side secured portion in the traveling body portion and provided with an insertion hole adapted to receive the shaft portion insertable therethrough along the travel line;
a first coil spring inserted through the first shaft portion in a state of being compressed between a first stopper attached to the first shaft portion and the first traveling body portion side secured portion, and
a second coil spring inserted through the second shaft portion in a state of being compressed between a second stopper attached to the second shaft portion and the second traveling body portion side secured portion.

5. The optical element switching apparatus according to claim 1,
wherein the holding portion includes
a cam guide mounted to one of the traveling body portion and the main body portion and extended along the travel line at an interval equal to or greater than an interval between the respective optical axes of the two types of optical elements, and
a pressing portion mounted to one of the main body portion and the traveling body portion and adapted to press a predetermined pressing body to the cam guide via an elastic force toward one of the main body portion and the traveling body portion, and
the cam guide includes
first and second slant portions each slant such that the pressing body comes closer to one of the main body portion and the traveling body portion as the traveling body portion comes close to the travel limit position in the vicinity of a point of a pressed surface against which the pressing body is pressed when the traveling body portion is at the travel limit position on the first or second directional side.

6. The optical element switching apparatus according to claim 5,
wherein respective inclination angles of the first and second slant portions are determined so that in one of the first and second slant portions, a holding force of the pressing portion applied to the cam guide in one of the second and first directions may be greater than a pressing force pressing the traveling body portion in one of the first and second directions.

7. The optical element switching apparatus according to claim 5,
wherein the pressing portion includes
an intermediate support body adapted to receive the elastic force applied thereto from one of the main body portion and the traveling body portion, and
a roller rotatably mounted to the intermediate support body.

8. The optical element switching apparatus according to claim 1,
wherein the holding portion continues to generate the drive force in the direction of shifting the traveling body portion by the control portion controlling the derive force generating portion.

9. A microscope system comprising:
a main body portion mounted with an objective lens focusing on an imaging object;
an imaging element imaging the imaging object via the objective lens and a predetermined optical element;
a traveling body portion mounted with two types of image forming lenses each forming an image of the imaging object on the imaging element;
a shifting portion adapted to shift the traveling body portion with respect to the main body portion so that respective optical axes of the two types of image forming lenses are each shifted on a predetermined travel line to align any one of the optical axes of the image forming lenses with the optical axis of the optical path;
a travel limit position defining portion adapted to define a travel limit position of the traveling body portion with respect to the main body portion, in relation to each of a first direction along the travel line and a second direction opposite to the first direction;
a drive force generating portion generating a drive force adapted to shift the traveling body portion in one of the first and second directions by a predetermined unit travel distance and transmitting the drive force to a predetermined transmission portion;
a connecting portion connecting the transmission portion with the traveling body portion via a predetermined elastic body and displacing the traveling body portion with respect to the transmitting portions in each of the first and second directions in a range of an elastic displacement width greater than the unit travel distance;
a holding portion applying a force greater than an elastic force occurring in the connecting portion to the traveling body portion shifted to the travel limit position, in a direction opposite the direction where the elastic force acts, so as to hold the traveling body portion at the travel limit position; and
a control portion adapted to control the drive force generating portion to supply a drive force capable of shifting the traveling body portion farther than the travel limit position when the traveling body portion is to be shifted.
